(19) United States
(12) Patent Application Publication
(10) Pub. No.: US 2014/0150731 A1
(43) Pub. Date: Jun. 5, 2014

(54) GAS CONTROL VALVE AND GAS APPLIANCE HAVING THE GAS CONTROL VALVE

(71) Applicant: GRAND MATE CO., LTD., Taichung (TW)

(72) Inventors: CHUNG-CHIN HUANG, Taichung (TW); CHIN-YING HUANG, Taichung (TW); HSIN-MING HUANG, Taichung (TW); HSING-HSIUNG HUANG, Taichung (TW); KUAN-CHOU LIN, Taichung (TW); YEN-JEN YEH, Yunlin (TW)

(73) Assignee: GRAND MATE CO., LTD., Taichung (TW)

(21) Appl. No.: 13/777,158

(22) Filed: Feb. 26, 2013

(30) Foreign Application Priority Data
Dec. 3, 2012 (TW) 101145301

(51) Int. Cl. F24H 9/20; F23N 1/00; F16K 31/06

(52) U.S. Cl. CPC F24H 9/2035; F16K 31/06; F23N 1/005
USPC 122/14.22; 251/129.04; 431/18

(57) ABSTRACT

A gas control valve includes a base, a stop device, a driving device. The base has a gas passageway therein for gas to flow therethrough. The stop device is provided in the base to be moved between a first position, in which the stop device narrows the gas passageway to allow a first gas flow flowing through the base, and a second position, in which the stop device allows a second gas flow flowing through the base, wherein the second gas flow is greater than the first gas flow. The driving device is controllable to move the stop device between the first position and the second position. Therefore, the gas control valve of the present invention may adjust the gas flow.

The current application claims a foreign priority to the patent application of Taiwan No. 101145301 filed on Dec. 3, 2012.

### BACKGROUND OF THE INVENTION

1. Field of the Invention

The present invention relates generally to a gas appliance, and more particularly to a gas control valve for a gas appliance.

2. Description of the Related Art

Gas appliance is a device which burns gas to heat something, such as gas water heater, gas fireplace, and gas dryer. Typically, the conventional gas appliance is provided with a gas control valve to open or close a gas pipe, which supplies gas to a burner. The conventional gas control valve has many advantages, including simple structure, small size, low power consumption, and fast reaction. However, it turns the gas on and off only.

While a gas control valve may adjust a gas flow for the burner, it may replace a gas regulator, which is a conventional device in the gas appliance to adjust the gas flow for the burner. As a result, it may take less space in the gas appliance and reduce the cost of manufacture.

### SUMMARY OF THE INVENTION

The primary objective of the present invention is to provide a gas control valve for a gas appliance, which has a simple structure to adjust gas flow.

According to the objective of the present invention, the present invention provides a gas control valve, including a base, a stop device, and a driving device. The base has a gas passageway therein for gas to flow therethrough. The stop device is provided in the base to be moved between a first position, in which the stop device narrows the gas passageway to allow a first gas flow flowing through the base, and a second position, in which the stop device allows a second gas flow flowing through the base, wherein the second gas flow is greater than the first gas flow. The driving device is controllable to move the stop device between the first position and the second position.

In an embodiment, the base has a main member and a valve tube; the main member has a first passageway and a second passageway; the first passageway is connected to the second passageway to form the gas passageway; and the valve tube is received in the gas passageway and has a portion in the first passageway and a portion in the second passageway, and valve tube has a passageway to communicate the first passageway with the second passageway.

In an embodiment, the stop device is attached to an end of the valve tube while the stop device is moved to the first position, and leaves the end of the valve tube while the stop device is moved to the second position.

In an embodiment, the stop member block a portion of the passageway of the valve tube when the stop device is moved to the first position.

In an embodiment, the stop member has a bore, a size of the bore is smaller than the passageway of the valve tube; and the bore is on the passageway of the valve tube when the stop device is moved to the first position.

In an embodiment, the driving device has an electromagnetic member to receive an electric signal and generate a magnetic field accordingly, and the stop device has a magnetic member to be attracted or repelled by the magnetic field of the electromagnetic member.

The present invention further provides a gas appliance, including a combustor for burning gas, and the gas control valve for controlling a gas flow supplied to the combustor.

In an embodiment, the gas appliance further includes a controller connected to the driving device of the gas control valve to control the driving device so as to move the stop member to the first position or to the second position.

In an embodiment, the controller generates an electric signal, and the driving device has an electromagnetic member to receive the electric signal from the controller and generate a magnetic field accordingly.

In an embodiment, the gas appliance further includes a water pipe above the combustor and a temperature sensor for detecting a temperature of water out of the water pipe, wherein the controller is connected to the controller; the controller controls the driving device to move the stop device to the second position while a temperature sensed by the temperature sensor is lower than a preset temperature, and to move the stop device to the first position while a temperature sensed by the temperature sensor is equal to or higher than the preset temperature.

In an embodiment, the gas appliance further includes a frame having a grilling room and a temperature sensor for detecting a temperature in the grilling room, wherein the controller controls the driving device to move the stop device to the second position while a temperature sensed by the temperature sensor is lower than a preset temperature, and to move the stop device to the first position while a temperature sensed by the temperature sensor is equal to or higher than the preset temperature.

Therefore, the gas control valve of the present invention may adjust the gas supplied to the combustor by electric signals.

### BRIEF DESCRIPTION OF THE DRAWINGS

FIG. 1 is a sketch diagram of the gas appliance of a first preferred embodiment of the present invention;

FIG. 2 is a perspective view of the gas control valve of the first preferred embodiment of the present invention;

FIG. 3 is a sectional view of the gas control valve of the first preferred embodiment of the present invention, showing the stop member at the first position;

FIG. 4 is a sectional view of the gas control valve of the first preferred embodiment of the present invention, showing the stop member at the second position;

FIG. 5 is a diagram, showing the relationship between the electric signal and the gas flow;

FIG. 6 a sketch diagram of the gas appliance of a second preferred embodiment of the present invention; and

FIG. 7 a sketch diagram of the gas appliance of a third preferred embodiment of the present invention.

### DETAILED DESCRIPTION OF THE INVENTION

The detailed description and technical contents of the present invention will be explained with reference to the accompanying drawings. However, the drawings are illustrative only but not used to limit the present invention.

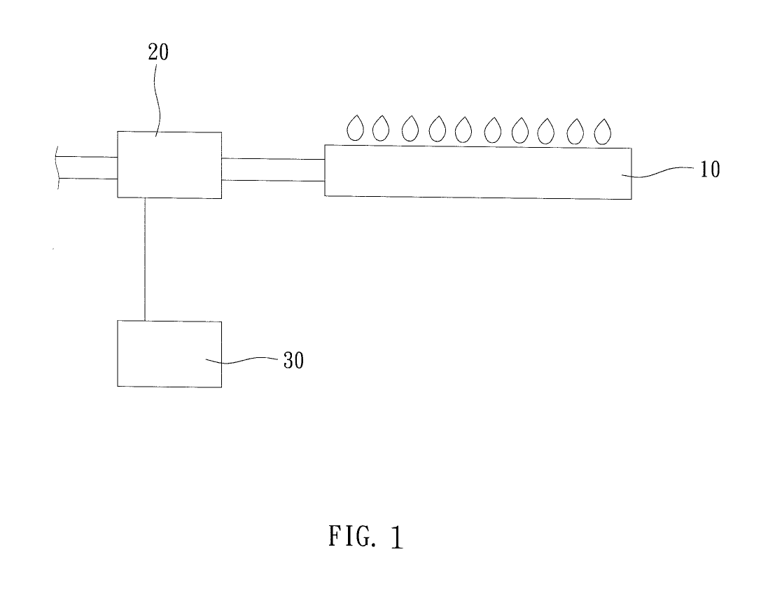

As shown in FIG. 1, we take a fireplace as a gas appliance of the first preferred embodiment of the present invention, which includes a combustor 10, a gas control valve 20, and a controller 30.

The combustor 10 burns gas to generate flames.

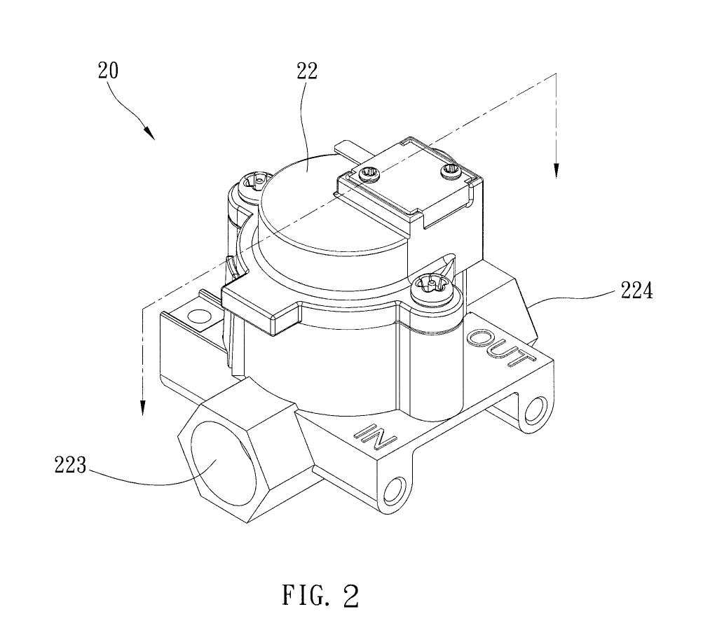

As shown in FIGS. from FIG. 2 to FIG. 4, the gas control valve 20 has a base 22, a driving device 24, and a stop device 26.

The base 22 has a main member 221 and a valve tube 222. The main member 221 has a first passageway 221a and a second passageway 222b. An end of the first passageway 221a is open at a side of the main member 221 to form an inlet 223, and an end of the second passageway 222b is open at an opposite side of the main member 221 to form an outlet 224. The valve tube 222 has an end screwed into the second passageway 222b, and has a portion left in the first passageway 221a. The valve tube 222 has a passageway, and the passageway has a first end 222a in the first passageway 221a and a second end 222b in the second passageway 222b. As a result, the first passageway 221a is connected to the second passageway 222b through the valve tube 222 to form a gas passageway. Gas enters the base 22 via the inlet 223, goes through the first passageway 221a, the valve tube 222, and the second passageway 222b in sequence, and leaves the base 22 via the outlet 224. The gas out of the base 22 will be supplied to the combustor 10.

The driving device 24 is received in the main member 221 of the base 22. The driving device 24 has an electromagnetic member 241, which receives an electric signal and generates a magnetic field accordingly. In an embodiment, the electromagnetic member 241 is an electromagnet.

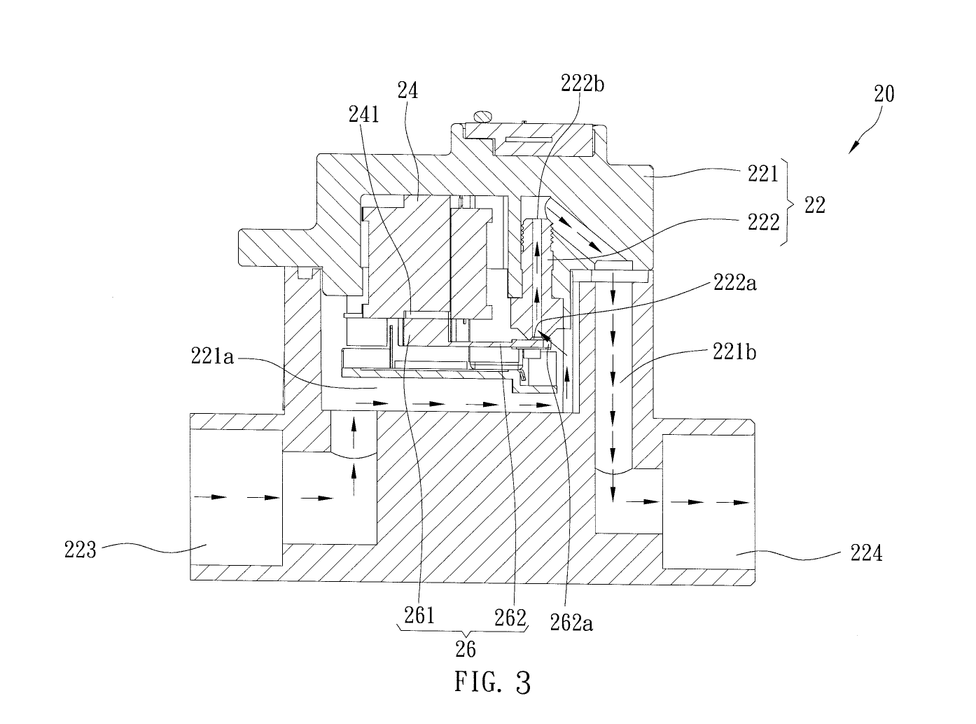

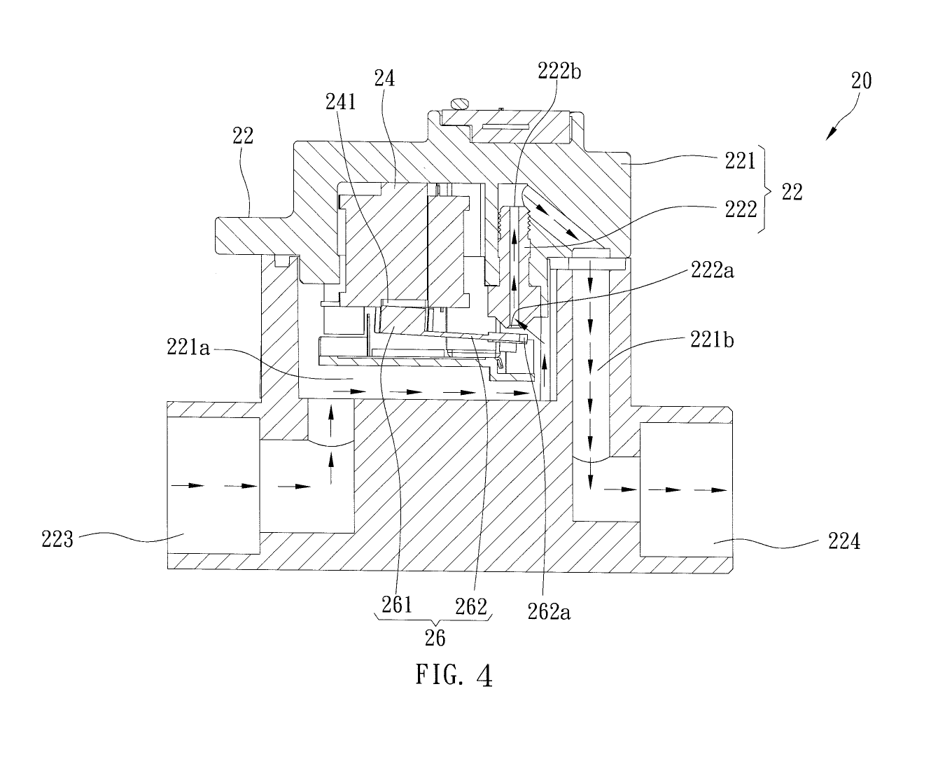

The stop device 26 is received in the main member 221 of the base 22 also. The stop device 26 has a magnetic member 261 in association with the electromagnetic member 241 and a plate 262 connected to the magnetic member 261. In an embodiment, the magnetic member 261 is a permanent magnet to be moved by the magnetic field of the electromagnetic member 241 so as to move the plate 262 between a first position (FIG. 3) and a second position (FIG. 4). The plate 262 has a bore 262a, and a size of the bore 262a is smaller than the first end 222a and the second end 222b of the valve tube 22. While the plate 262 is moved to the first position, the plate 262 is attached to the valve tube 22 and the bore 262a is on the first end 222a, and the plate 262 leaves the valve tube 22 while the plate 262 is moved to the second position.

The controller 30 is connected to the driving device 24 of the gas control valve 20 to activate the driving device 24 so as to move the stop device 26. In an embodiment, the controller 30 sends an electric signal to the electromagnetic member 241, and the electromagnetic member 241 generates a specific magnetic field accordingly to attracts or repels the magnetic member 261, so as to move the plate 262 to the first position or to the second position.

While the plate 262 is moved to the first position, a low gas flow flows through the bore 262a. In this condition, the gas control valve 20 provides a first gas flow. While the plate 262 is moved to the second position, a high gas flow flows through the valve tube 222 without a block of the plate 262. In this condition, the gas control valve 20 provides a second gas flow. It is obvious that the second gas flow is greater than the first gas flow.

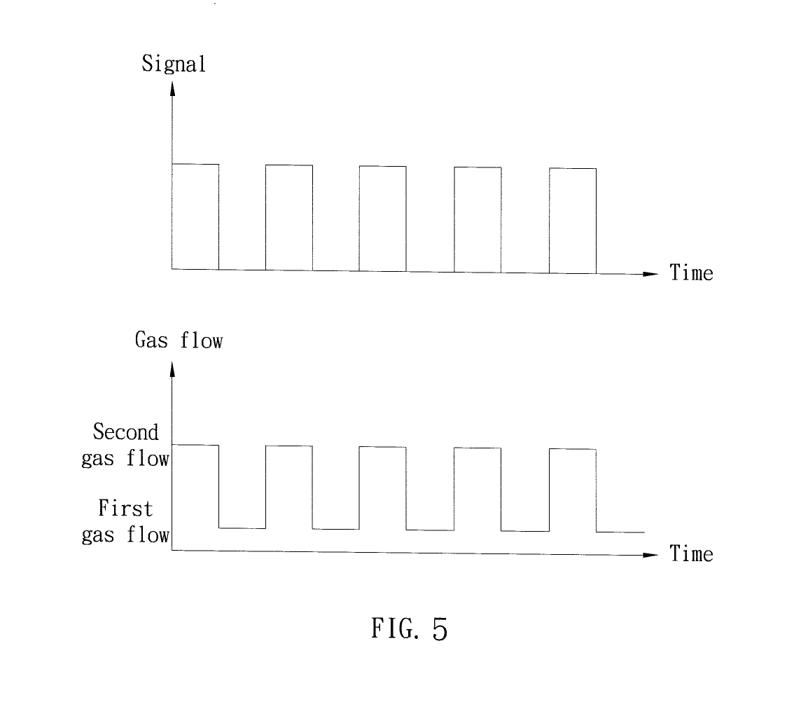

As shown in FIG. 5, the controller 30 sends pulse width modulation (PWM) signals to the electromagnetic member 241 to repeatedly and continuously move the plate 262 between the first position and the second position. As a result, it may reduce the gas consumption of the fireplace and still keep the flames in the same size (by visual).

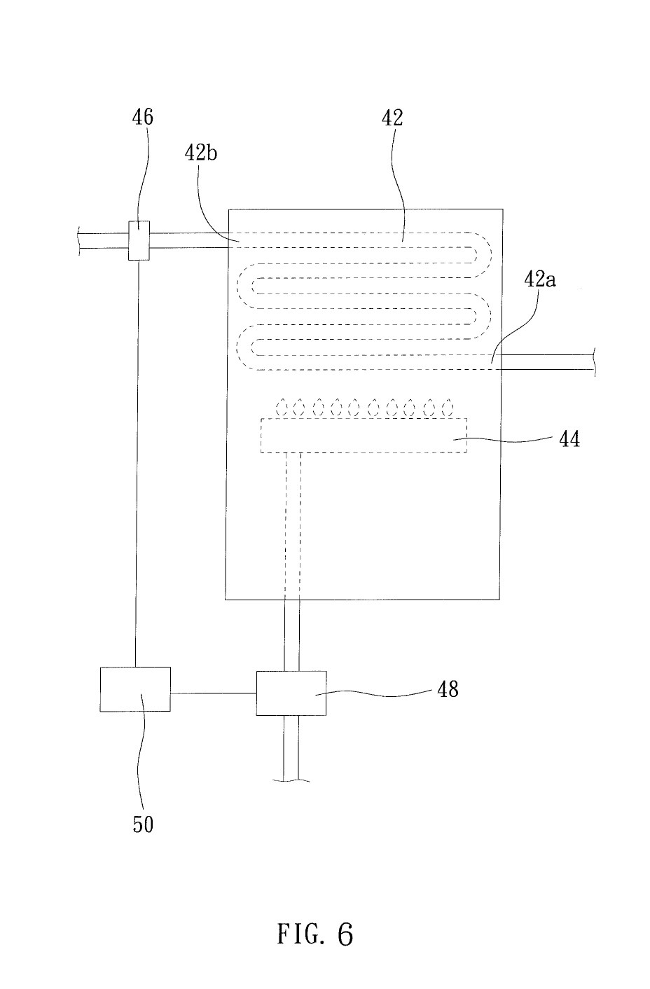

FIG. 6 shows a gas water heater of the second preferred embodiment of the present invention, including a water pipe 42, a combustor 44, a temperature sensor 46, a gas control valve 48, and a controller 50.

The water pipe 42 has an inlet 42a and an outlet 42b. Water enters the water pipe 42 via the inlet 42a, and leaves via the outlet 42b. The combustor 44 is under the water pipe 42 to burn gas and heat the water in the water pipe 42.

The temperature sensor 46 is provided at the outlet 42b of the water pipe 42 to sense a temperature of the water out of the water pipe 42.

The gas control valve 48 and the controller 50 are the same as above. The gas control valve 48 is switched to provide the second gas flow (high gas flow) when the temperature sensor 46 senses that the water temperature is lower than a preset temperature, and is switched to provide the first gas flow (low gas flow) when the temperature sensor 46 senses that the water temperature is equal to or higher than the preset temperature. That may make the water heater to provide hot water with a constant temperature.

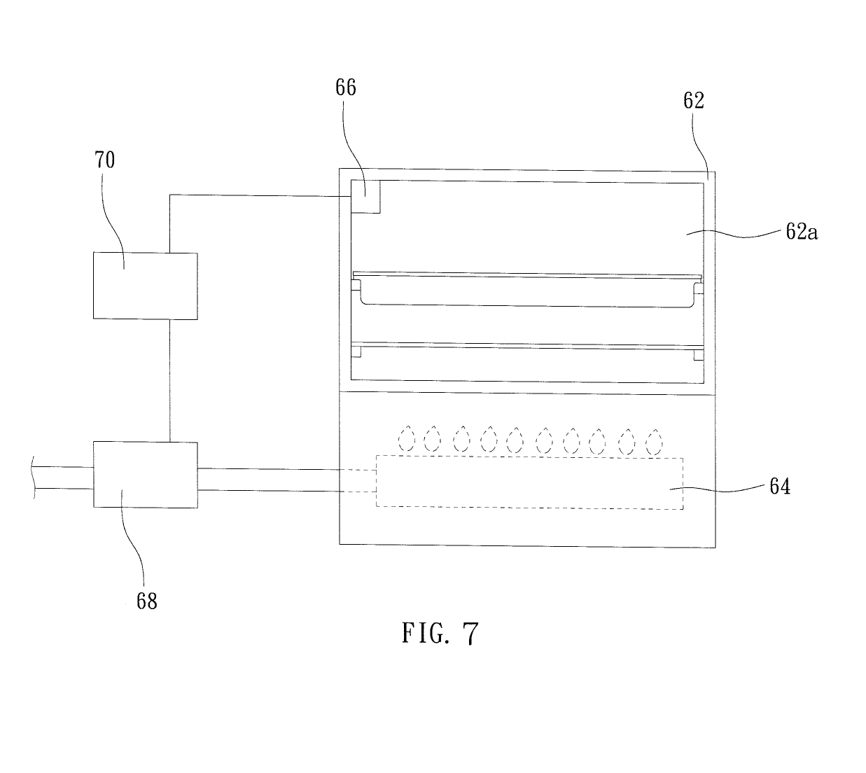

FIG. 7 shows a gas grill of the third preferred embodiment of the present invention, including a frame 62, a combustor 64, a temperature sensor 66, a gas control valve 68, and a controller 70.

The frame 62 has a grilling room 62a inside, and the combustor 64 is under the grilling room 62a to heat foods in the grilling room 62a.

The temperature sensor 66 is provided in the grilling room 62a to sense a temperature in the grilling room 62a.

The gas control valve 68 and the controller 70 are the same as above. The gas control valve 68 is switched to provide the second gas flow (high gas flow) when the temperature sensor 66 senses that the temperature is lower than a preset temperature, and is switched to provide the first gas flow (low gas flow) when the temperature sensor 66 senses that the temperature is equal to or higher than the preset temperature. That may make the gas grill have a constant grilling temperature.

It is noted that the gas control valve and the controller of the present invention may be incorporated in any kind of gas appliance. The description above is a few preferred embodiments of the present invention, and the equivalence of the present invention is still in the scope of claim construction of the present invention.

What is claimed is:

1. A gas control valve, comprising:
a base having a gas passageway therein for gas to flow therethrough;
a stop device provided in the base, wherein the stop device is moved between a first position, in which the stop device narrows the gas passageway to allow a first gas flow flowing through the base, and a second position, in which the stop device allows a second gas flow flowing through the base, wherein the second gas flow is greater than the first gas flow; and
a driving device for controllable to move the stop device between the first position and the second position.

2. The gas control valve as defined in claim 1, wherein the base has a main member and a valve tube; the main member has a first passageway and a second passageway; the first passageway is connected to the second passageway to form the gas passageway; and the valve tube is received in the gas passageway and has a portion in the first passageway and a portion in the second passageway, and valve tube has a passageway to communicate the first passageway with the second passageway.

3. The gas control valve as defined in claim 2, wherein the stop device is attached to an end of the valve tube while the stop device is moved to the first position, and leaves the end of the valve tube while the stop device is moved to the second position.

4. The gas control valve as defined in claim 3, wherein the stop member block a portion of the passageway of the valve tube when the stop device is moved to the first position.

5. The gas control valve as defined in claim 3, wherein the stop member has a bore, a size of the bore is smaller than the passageway of the valve tube; and the bore is on the passageway of the valve tube when the stop device is moved to the first position.

6. The gas control valve as defined in claim 1, wherein the driving device has an electromagnetic member to receive an electric signal and generate a magnetic field accordingly, and the stop device has a magnetic member to be attracted or repelled by the magnetic field of the electromagnetic member.

7. A gas appliance, comprising:
a combustor for burning gas;
a gas control valve for controlling a gas flow supplied to the combustor, comprising:
a base having a gas passageway therein for gas to flow therethrough;
a stop device provided in the base, wherein the stop device is moved between a first position, in which the stop device narrows the gas passageway to allow a first gas flow flowing through the base, and a second position, in which the stop device allows a second gas flow flowing through the base, wherein the second gas flow is greater than the first gas flow; and
a driving device for controllable to move the stop device between the first position and the second position.

8. The gas appliance as defined in claim 7, further comprising a controller connected to the driving device of the gas control valve to control the driving device so as to move the stop member to the first position or to the second position.

9. The gas appliance as defined in claim 8, wherein the controller generates an electric signal, and the driving device has an electromagnetic member to receive the electric signal from the controller and generate a magnetic field accordingly.

10. The gas appliance as defined in claim 8, further comprising a water pipe above the combustor and a temperature sensor for detecting a temperature of water out of the water pipe, wherein the controller is connected to the controller; the controller controls the driving device to move the stop device to the second position while a temperature sensed by the temperature sensor is lower than a preset temperature, and to move the stop device to the first position while a temperature sensed by the temperature sensor is equal to or higher than the preset temperature.

11. The gas appliance as defined in claim 8, further comprising a frame having a grilling room and a temperature sensor for detecting a temperature in the grilling room, wherein the controller controls the driving device to move the stop device to the second position while a temperature sensed by the temperature sensor is lower than a preset temperature, and to move the stop device to the first position while a temperature sensed by the temperature sensor is equal to or higher than the preset temperature.
